(19) United States
(12) Patent Application Publication
(10) Pub. No.: US 2012/0147055 A1
(43) Pub. Date: Jun. 14, 2012

(54) SYSTEM AND METHOD FOR ORGANIZING AND PRESENTING CONTENT ON AN ELECTRONIC DEVICE

(76) Inventors: MATT PALLAKOFF, Mountain View, CA (US); Jeff E. Tycz, Palo Alto, CA (US); Jennifer D. Ng, San Francisco, CA (US); Josh Feldman, San Francisco, CA (US)

(21) Appl. No.: 13/235,270

(22) Filed: Sep. 16, 2011

Related U.S. Application Data
(60) Provisional application No. 61/383,635, filed on Sep. 16, 2010.

(51) Int. Cl. G09G 5/34; G06F 3/048

(52) U.S. Cl. 345/672; 715/784

(57) ABSTRACT

A system and method for organizing new content on the user interface of an electronic device. Graphical representations (e.g., book or album covers or icons) representing the content that the user is most likely going to want to open next are presented on a virtual shelf on the user interface of the device. The graphical representations are preferably organized in receding order of likelihood of opening from left to right. As new items appear on the virtual shelf, older items are shifted to the right. A limited number of items (graphical representations) can be depicted at one time on the virtual shelf on the display of the device. The shelf can be scrolled left and right to view all of the items on the shelf.

### CROSS REFERENCE TO RELATED APPLICATIONS

This application claims priority to U.S. Provisional Application No. 61/383,635, filed on Sep. 16, 2010, the entirety of which is incorporated herein by reference.

### FIELD OF THE INVENTION

The present invention generally relates to systems and methods for operating an electronic device, and more particularly to systems and methods for organizing and displaying available content to a user of the electronic device.

### BACKGROUND OF THE INVENTION

On some conventional tablet computers, electronic content such as magazines is often packaged as an application (“app”), and when an issue is downloaded its graphical representation (e.g. a cover or icon) is placed at the end of the user interface's screen full of app icons. These icons, representing the user's new content stay in these positions on the screen (or off the screen) unless and until the user manually moves the icon. In other conventional tablet computers, the icons can be ordered alphabetically or by “most recent” order, but the user can not freely re-order or re-position specific items that the user is more interested in than other items.

If the user has accumulated many dozens or hundreds of new content items, both of these types of organizations of graphical representations quickly becomes tedious to navigate. The conventional organization of content often makes it difficult to find specific content. People tend to resort to using the device's search function for finding the desired content on their devices, assuming they can even remember the name associated with the content. Conventional organizational schemes make little effort to automatically elevate to a position of prominence the graphical representation (covers and icons) of items that a user is most likely to want to open next, while also giving users the ability to customize the organization of those items of interest to reflect the user's specific levels of interest in each item.

### SUMMARY OF THE INVENTION

The present invention is a system and method for organizing content of interest on the user interface of an electronic device. In a preferred embodiment, the device is a portable electronic reader (e.g., an e-reader). Although the primary use of the e-reader can be for reading electronic books, other types of electronic content can be viewed/listened to/operated on the device, such as digital magazines, newspapers, music and software applications.

Graphical representations (e.g., book or album covers or icons) representing the content that the user is most likely going to want to open next are presented on a virtual shelf on the user interface of the device. Preferably, the graphical representations are organized in receding order of likelihood of opening from left to right. The order of organization on the virtual shelf involves using heuristics and judgment calls. In the preferred embodiment, the following types of content are added to the virtual shelf: the latest issue of any magazine or newspaper to which the user subscribes; books recommended or lent to the user; newly purchased books or periodicals; and any item the user opens from within her library on the device.

One of the principles governing the operation of the present invention is that users will often want to open the content/material that they have most recently acquired/used. By placing graphical representations (covers or icons) of new or recently used or preferred material on, and preferably near the front of the virtual shelf of the present invention, the user does not have to search through her library/directory or whatever other organizational scheme is used on the device in order to find this material again.

In a preferred embodiment, as new items appear on the virtual shelf, older items are shifted to the right. Although only a limited number of items (graphical representations) can be depicted at one time on the virtual shelf on the screen of the device, the shelf can be scrolled left and right to view all of the items on the shelf. In a preferred embodiment, only the most recent 50 or so items are kept on the shelf. The user can always find all of her content items in her library. The focus of the present invention is to elevate the items the users are most likely to want to open next, including the most recently purchased or opened items.

Another principle governing preferred embodiments of the present invention is that users should be allowed to reorder or reorganize items on the shelf (including removing or adding items to the shelf), to reflect their current interests. This is useful for time when the system's heuristics don't automatically generate an order that completely matches those interests.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a system in which the present invention operates;

FIG. 2 depicts a user interface aspect of the present invention, open at bottom of the screen of a user device;

FIG. 3 is a user interface aspect of the present invention, for a user after the purchase of new content;

FIG. 4 illustrates a user interface aspect of the present invention, for a recipient user after the loan of content;

FIG. 5 illustrates a user interface aspect of the present invention, for a recipient user after the loaned content has been moved on the interface;

FIG. 6A is the a user interface aspect of the present invention, for a user before the recommendation of new content;

FIG. 6B is a user interface aspect of the present invention, for a recipient user after the recommendation of new content; and

FIG. 7 illustrates an embodiment of an electronic device according to the present invention.

### DETAILED DESCRIPTION OF THE INVENTION

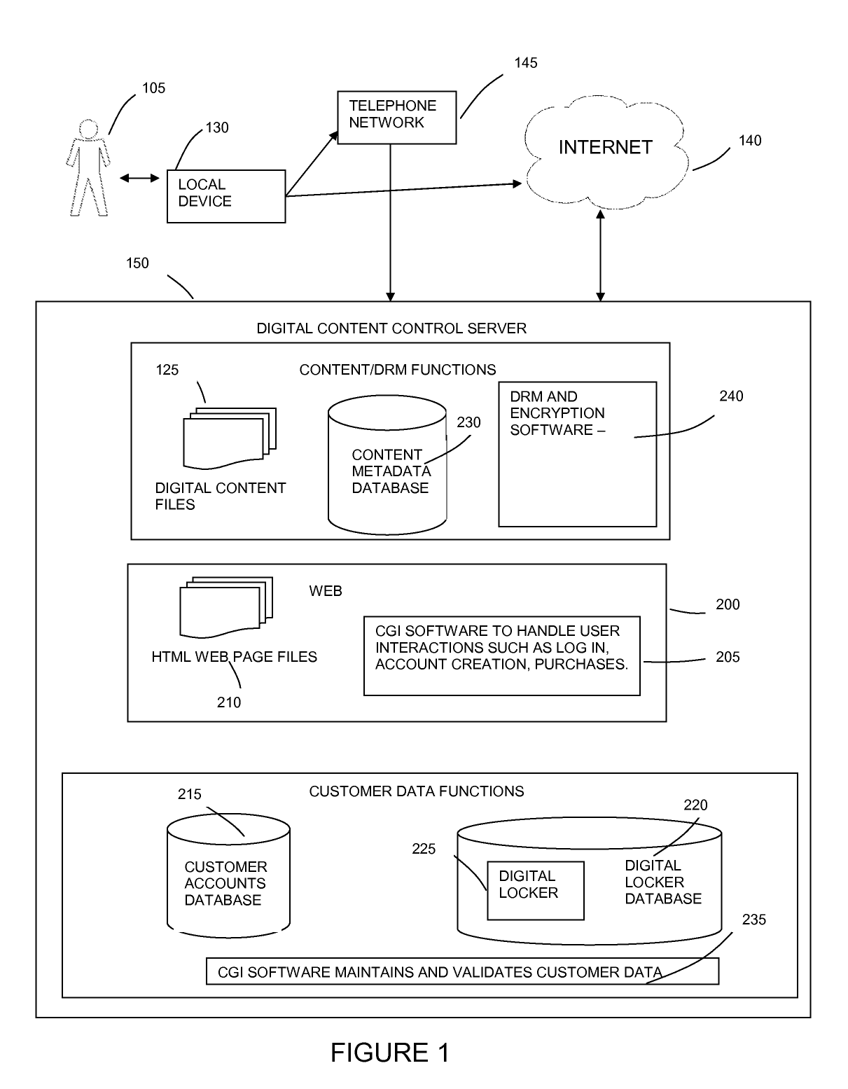

FIG. 1 shows components of a system in which the present invention operates. User 105 is an authorized user of the system. Many of the functions of the system are carried out on digital content control server 150. As appreciated by those skilled in the art, many of the functions described herein can be divided between the digital content control server 150 and the user's local electronic device 130. Further, as also appreciated by those skilled in the art, digital content control server 150 can be considered a “cloud” with respect to the user 105 and her local device 130. The cloud can actually be comprised of several servers performing interconnected and distributed functions. The user 105 can connect to the digital content control server 150 via the Internet 140, a telephone network 145 (e.g., a cellphone network) or other suitable electronic communication means. The connection to the Internet 140 or the telephone network 145 is preferably wireless using WiFi to a network access point or through the cellular system. User 105 has an account on digital content control server 150, which authorizes user 105 to use the system.

Associated with the user's 105 account is the user's 105 digital locker 225 located on the digital content control server 150 in a digital locker database 220. As further described below, in the preferred embodiment, each user's digital locker 225 contains links to copies of digital content 125 purchased (or otherwise legally acquired) by user 105.

Indicia of rights to all copies of digital content 125 owned by user 105, including digital content 125, is stored by reference in the user's digital locker 225. Digital locker 225 is a remote online repository that is uniquely associated with the user's 105 account. As appreciated by those skilled in the art, the actual copies of the digital content 125 purchased by user 105 are not necessarily stored in the user's locker 225, but rather the locker 225 stores an indication of the rights of the user to the particular content 125 and a link or other reference to the actual digital content 125. Typically, the actual copy of the digital content 125 is stored in another mass storage (not shown). The digital lockers 225 of all of the users 105 who have purchased a copy of a particular digital content 125 would point to this copy in mass storage. Of course, back up copies of all digital content 125 are maintained for disaster recovery purposes. Although only one example of digital content 125 is illustrated in this Figure, it is appreciated that the digital content control server can contain millions of files 125 containing digital content. It is also contemplated that the digital content control server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

User 105 can access his or her digital locker 225 using a local device 130. Local device 130 is an electronic device such as a personal computer, an e-book reader, a smart phone or other electronic device that the user 105 can use to access the digital content control server 150. In a preferred embodiment, the local device has been previously associated (registered) with the user's 105 account using user's 105 account credentials. Local device 130 provides the capability for user 105 to download user's 105 copy of digital content 125 via his or her digital locker 225. After digital content 125 is downloaded to local device 130, user 105 can engage with the downloaded content locally, e.g., read the book, listen to the music, watch the video, or execute the application.

In a preferred embodiment, local device 130 includes a non-browser based device interface that allows user 105 to initiate the purchase of digital content 125 in a non-browser environment. Through the device interface, the user 105 is automatically connected to the digital content control server 150 in a non-browser based environment. This connection to the digital content control server is a secure interface and can be through the telephone network 145, typically a cellular network for mobile devices. If user 105 is accessing his or her digital locker 225 using the Internet 140, local device 130 also includes a web account interface. Web account interface provides user 105 with browser-based access to his or her account and digital locker 225 over the Internet 140. The web interface allows user 105 to initiate the purchase of digital content 125 in a browser based environment.

Digital content control server 150 handles front-end functions related to web server operations and user interactions with web and device interfaces in connection with the user's local devices 130. Digital content control server 150 also handles all backend functions of the digital content control system related to managing accounts, maintaining digital locker records, maintaining content metadata, and providing encryption services.

Digital content control server 150 provides both the browser based web interface and non browser based device interface. User 105 may engage with web interface or device interface to initiate a purchase.

Digital content control server 150 employs web server 200 including web services interface software 205 to handle interactions between front-end components; such as device interface, web account interface, and web interface; and back-end database components of the digital content control system. Web server 200 services include serving up the web pages 210 that comprise web account interface and web interface, and the underlying web services associated with device interface. Web services interface software 205 includes handling users' logins to their accounts and processing the initiation of and response to purchase requests.

Back-end database components of the system include customer accounts database 215, digital lockers database 220, and content metadata database 230. Records for users' accounts are stored and managed in customer accounts database 215. Records for digital lockers 120 are stored and managed in digital lockers database 220. Content metadata database 230 serves as a source of metadata for individual digital content items 125 in the digital content control system.

Web services interface software 205 in the web server 200 interfaces with customer data services 235 to update customer accounts database 215, and digital lockers database 220. Customer data services 235 processes database updates such as maintaining and validating customer data in users' accounts.

In the preferred embodiment of the invention, the system supports the distribution and use of electronic books (eBooks) or digital periodicals. Although the eBook and periodical application is the preferred embodiment, as appreciated by those skilled in the art, the system not limited to user 105 purchasing and using eBooks or digital publications. The system can be used for purchase and use of any digital content, such as digital movies, digital music, digital audio books, digital pictures, software applications or other downloadable digital content.

In the preferred embodiment of the invention, local device 130 is a mobile electronic reader (eReader) device. The embodiment of the invention is not intended to limit local device 130 to a mobile eReader device. Local device 130 may be a desktop personal computer or another type of mobile consumer electronic device, such as, for example, a cell phone, a smartphone, a laptop computer, a tablet computer or other such mobile digital device.

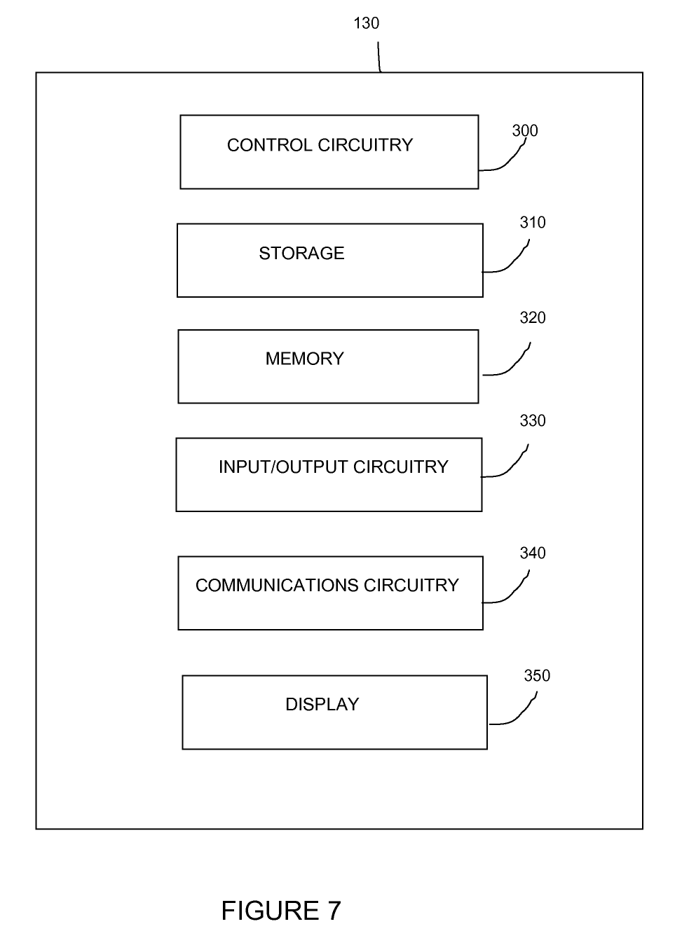

FIG. 7 illustrates an exemplary local device 130. As appreciated by those skilled in the art, the local device can take many forms capable of operating the present invention. As previously described, in a preferred embodiment the local device 130 is a mobile electronic device, and in an even more preferred embodiment device 130 is an eBook reader. Electronic device 130 can include control circuitry 300, storage 310, memory 320, input/output (“I/O”) circuitry 330, communications circuitry 340, and display 350. In some embodiments, one or more of the components of electronic device 130 can be combined or omitted (e.g., storage 310 and memory 320 may be combined). As appreciated by those skilled in the art, electronic device 130 can include other components not combined or included in those shown in FIG. 7 (e.g., a power supply such as a battery, and an input mechanism).

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 300 can include any processing circuitry or processor operative to control the operations and performance of electronic device 130. For example, control circuitry 300 can be used to run operating system applications, firmware applications, media playback applications, media editing applications, or any other application. Control circuitry 300 can drive the display 350 and process inputs received from a user interface (e.g., the display 350 if it is a touch screen).

Storage 310 can include, for example, one or more storage mediums including a hard-drive, solid state drive, flash memory, permanent memory such as ROM, any other suitable type of storage component, or any combination thereof. Storage 310 can store, for example, media content (e.g., eBooks, music and video files), application data (e.g., software for implementing functions on electronic device 130), firmware, user preference information data (e.g., content preferences), authentication information (e.g. libraries of data associated with authorized users), transaction information data (e.g., information such as credit card information), wireless connection information data (e.g., information that can enable electronic device 130 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

Memory 320 can include cache memory, semi-permanent memory such as RAM, and/or one or more different types of memory used for temporarily storing data. In some embodiments, memory 320 can also be used for storing data used to operate electronic device applications, or any other type of data that can be stored in storage 310. In some embodiments, memory 320 and storage 310 can be combined as a single storage medium.

I/O circuitry 330 can be operative to convert (and encode/decode, if necessary) analog signals and other signals into digital data. In some embodiments, I/O circuitry 330 can also convert digital data into any other type of signal, and vice-versa. For example, I/O circuitry 330 can receive and convert physical contact inputs (e.g., from a multi-touch screen, i.e., display 350), physical movements (e.g., from a mouse or sensor), analog audio signals (e.g., from a microphone), or any other input. The digital data can be provided to and received from control circuitry 300, storage 310, and memory 320, or any other component of electronic device 130. Although I/O circuitry 330 is illustrated in FIG. 7 as a single component of electronic device 130, several instances of I/O circuitry 330 can be included in electronic device 130.

Electronic device 130 can include any suitable interface or component for allowing a user to provide inputs to I/O circuitry 330. For example, electronic device 130 can include any suitable input mechanism, such as for example, a button, keypad, dial, a click wheel, or a touch screen (e.g., display 350). In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers (e.g., mono or stereo speakers) built into electronic device 130, or an audio component that is remotely coupled to electronic device 130 (e.g., a headset, headphones or earbuds that can be coupled to a communications device with a wire or wirelessly).

Display 350 includes the display and display circuitry for providing a display visible to the user. For example, the display circuitry can include a screen (e.g., an LCD screen) that is incorporated in electronics device 130. In some embodiments, the display circuitry can include a coder/decoder (Codec) to convert digital media data into analog signals. For example, the display circuitry (or other appropriate circuitry within electronic device 1) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the electronic device 130, information regarding ongoing communications operations, information regarding incoming communications requests, or device operation screens) under the direction of control circuitry 300. Alternatively, the display circuitry can be operative to provide instructions to a remote display.

Communications circuitry 340 can include any suitable communications circuitry operative to connect to a communications network and to transmit communications (e.g., data) from electronic device 130 to other devices within the communications network. Communications circuitry 340 can be operative to interface with the communications network using any suitable communications protocol such as, for example, Wi-Fi (e.g., a 802.11 protocol), Bluetooth, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

Electronic device 130 can include one or more instances of communications circuitry 340 for simultaneously performing several communications operations using different communications networks, although only one is shown in FIG. 7 to avoid overcomplicating the drawing. For example, electronic device 130 can include a first instance of communications circuitry 340 for communicating over a cellular network, and a second instance of communications circuitry 340 for communicating over Wi-Fi or using Bluetooth. In some embodiments, the same instance of communications circuitry 340 can be operative to provide for communications over several communications networks.

In some embodiments, electronic device 130 can be coupled with a host device such as digital content control server 150 for data transfers, synching the communications device, software or firmware updates, providing performance information to a remote source (e.g., providing riding characteristics to a remote server) or performing any other suitable operation that can require electronic device 130 to be coupled to a host device. Several electronic devices 130 can be coupled to a single host device using the host device as a server. Alternatively or additionally, electronic device 130 can be coupled to several host devices (e.g., for each of the plurality of the host devices to serve as a backup for data stored in electronic device 130).

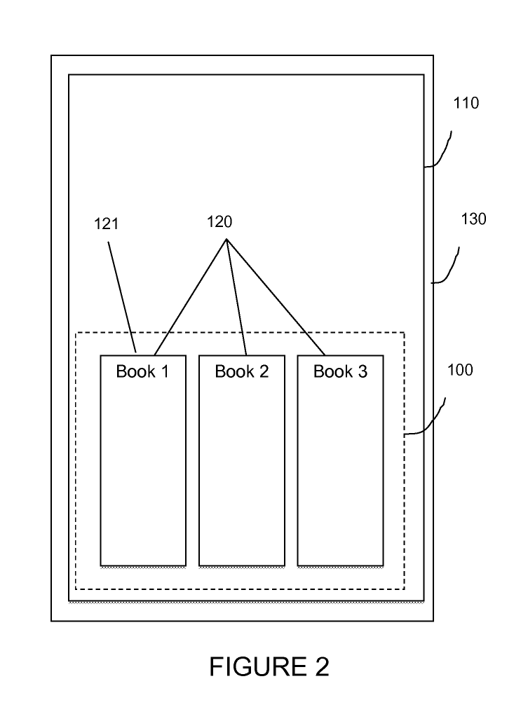

FIG. 2 illustrates a first embodiment of the virtual shelf of the present invention. As previously described, the present invention operates on a user's electronic device 130, preferably an eReader, in conjunction with the above described server based system as illustrated in FIG. 1. The virtual shelf 100 of the present invention is displayed on the screen 110 on device 130 and is unlike any physical counterpart or conventional electronic interface. The shelf 100 is populated with graphic representations of content 120 (e.g., covers or icons) that is owned by the user, or to which the user otherwise has rights. In the preferred embodiment, and as used throughout this specification for illustrative purposes, the content 120 to which the graphical representations refer comprises eBooks but could also be other digital content such as digital movies, digital magazines, digital newspapers, digital music, digital audio books, digital pictures, digital videos, software applications or other downloadable digital content.

The shelf 100 is updated continuously and automatically with new entries as the user uses the device 130 and obtains rights, recommendations, or other references to more content 120. The shelf 100 is updated in a way that quickly becomes natural and intuitive to the user, while preserving maximum user choice in interface layout and dynamics.

The graphic representations 120 depicted on the screen 110 may include, but are not limited to the cover art associated with the electronic media including eBooks, CDs and DVDs, the covers of periodicals and publications as typically found in their physical form in a library or bookstore. For other digital media, such as software applications, the graphical representation can be an icon that is typically associated with the application.

The left most position 121 on the shelf 100 is an important position and has specific semantics associated therewith. This position is 121 preferably allocated to the most recent new addition to the shelf 100, and is the only “reserved position” on the shelf 100. The user is free to move any media item 120 to any position on the shelf 100, including this one, but as soon as a new content item, e.g., Book 1 as illustrated in FIG. 2, is delivered to the user's electronic device 130, that new item is automatically placed in the left-most position 121 shifting other items right to make room.

Membership in the set of elements 120 populating the shelf 100 is defined by a set of possible trigger events and rules that are applied to them. In a preferred embodiment, interactivity on the elements 120 contained on the shelf 100 is conducted with a set of gestures or other appropriate user behaviors specified for interaction with one or more user-interface instantiations of the invention.

The rules for populating the shelf 100 are preferably embodied on the device 130 and can be modified/upgraded via the “compute cloud” (i.e., the digital content control server 150 (FIG. 1)) via a wireless network connection such as, but not limited to, a WiFi or cellular connection. Embodiments may also allow users to configure the rules (such as choosing not to display new recommendations on the shelf, or choosing to show only the most recent issue of a given digital periodical subscription instead of multiple recent issues).

In a preferred embodiment, the user interacts with the device 130 via a set of user-interface gestures, button presses and other interactive behaviors conformant to the interface conventions instantiated as standards throughout the interface. In the preferred embodiment, the shelf 100 is a mostly static user interface element on the home screen of the electronic reader 130, though the items on the shelf move.

Placement of content 120 on the shelf 100 can be affected by trigger events that may or may not be initiated on the device 130 on which the shelf 100 is resident. These trigger events may include, but are not limited to, for example: explicit opening of the shelf 100 by the user with the intent of, for example, placing a media object 120 on it; receipt of a loaned, recommended, or otherwise shared media content item 120; purchase of an electronic book, publication, software application, or other media content 120.

In one embodiment of the present invention, placement of content 120 on the shelf 100 is governed by a set of rules that may include, but are not limited to, those illustrated in Table 1.

TABLE 1
Items can be dragged from the home screen to the shelf 100 at any
location, or vice-versa
Newly purchased items that were downloaded to the device's library
Items lent from a friend
Items recommended by a friend
Promotional newsletter (option to unsubscribe)
Show an item representing a Secure Digital (SD) memory card when
plugged in
Show an item representing a “welcome video”
Show an item representing Blogs to which the user has subscribed
Any item that was open and read
Any application that was open and read/executed

The portion of the present invention resident on the device 130 is designed to interact as appropriate with computational processes, events, and other functionalities that are located on the digital content control server 150 and communicated to an individual electronic reader 130 via the network (either the telephone network 145 or the Internet 140 (FIG. 1)). Such processes and events may include, but are not limited to, calculation of one or more recommendations for specific media purchases to the user, communications between users of the system, and any other transactions normally found within network-based computing environments, as depicted in FIG. 1.

In one embodiment of the present invention, digital content control server 150 can be used to “push” media items 120 to end-users' electronic devices 130 (e.g., eReaders) based on certain trigger events that may include, but are not limited to: actions by other users who also own eReaders 130; actions by other users who may or may not own similar devices which, in turn, may or may not be connected to similar or the same networks; geographically triggered events like proximity to a certain location (e.g., a store); purchasing opportunities including, but not limited to, special offers, discounts, and other promotional activities.

In one embodiment, the proprietor of digital content control server 150 can send users a weekly newsletter. This newsletter can be a catalog of recommended books, potentially with extra content like author interviews. Each new newsletter issue can appear on the user's shelf 100, just like a magazine subscription. As soon as the user opens the newsletter, it will open a full screen catalog reader, which opens many marketing opportunities for the proprietor. The catalog can be populated with books specifically targeted for each user (e.g., based on their purchasing habits), and can include related content like author interview videos, reviews, etc.

User-centric databases or other information repositories that allow the system to compute reasonable predictions about a user's particular likes and dislikes in media content items and types, including, but not limited to, electronic books, periodicals, music and videos, software applications, and miscellaneous arts- and graphics-based content including, for example, electronic calendars can be used in conjunction with the present invention. Algorithms suitable to this end include heuristics and other statistical techniques that consolidate information gleaned from both individual and group behaviors.

All software code required to implement and mediate the functionality, interactions including commercial transactions, operational modalities, network and database (DB) operations, and user behaviors are consistent with the previously enumerated components of the system.

The basic operation of the system and method of the present invention is illustrated by the following examples. These examples assume the existence of three users of electronic readers 130, referred to throughout this section as User A, User B and User C. FIG. 2 illustrates the state of the user interface of User A's device 130 before any changes to the shelf 100. Shelf 100 had previously been populated with three elements of content 120, Book 1, Book 2 and Book 2. Again, as appreciated by those skilled in the art, the use of eBooks in this specification is exemplary only and the present invention can work with any type of digital content.

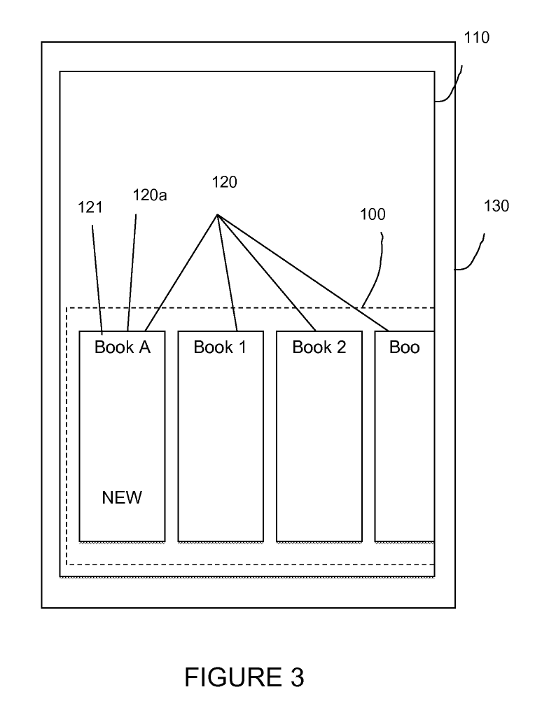

User A purchases an electronic book 120a from an online purveyor of the same (e.g., the owner of digital content control server 150), and after a short interval, the newly purchased title 120a appears in the leftmost position 121 on the shelf 100, as illustrated in FIG. 3B. As new items appear on the shelf 100 (e.g., new Book A), older items are shifted to the right on shelf 100 (e.g., Book 1, Book 2).

The view of shelf 100 on the screen 110 can be shifted to the left or to the right to show all of the content items 120 held on the shelf 100. In a preferred embodiment, this shifting is accomplished by a swiping gesture on touch screen 110 on the area of the shelf 100. In a preferred embodiment, only the most recent 50 or so items of content 120 are kept on the shelf 100. The user can always find all of the content items 120 that they own or have rights to in the library, directory or similar organizational function employed on their device 130. The present invention involving the shelf 100 is focused on enhancing the accessibility of the content items 120 that users are most likely to want to open next, including the user's most recently purchased or opened items 120. This feature of the present invention thus provides a technical contribution and advantage over the conventional organizational systems. As described above, in the conventional system the user has to search for her most recent content using the traditional methods of searching. The user may not even remember or know the name of her recent content. Through the use of the present invention, all of the user's most recent material is stored on the shelf 100 and can be easily found and quickly accessed.

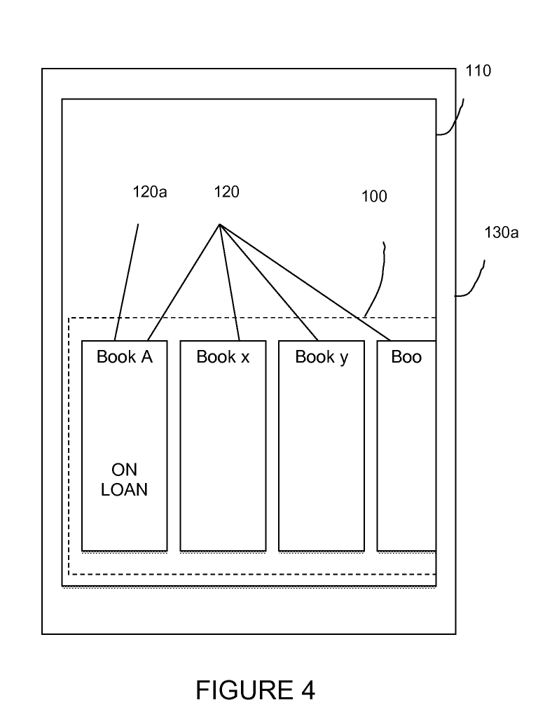

As shown in FIGS. 3 and 4, User A can loan her new book 120a to another user. In one embodiment, User A taps on title of her new purchase 120a in the shelf 100. This gesture opens up book 120 a in a Reader application, which is part of overall system included on device 130. With content 120a selected, the user can select “Share” from an appropriate menu that can be invoked by the user. In the “Share” menu, the user selects the “LendMe” (i.e., loan this item) option, and selects User B as the target of the prospective loan of the book 120a.

As shown in FIG. 4, User B has the shelf 100 open on her electronic reader 130a. After the loan of book 120a from User A to User B has been processed by the digital content control server 150 (FIG. 1), the loaned book 120a appears on User B's shelf 100 in the leftmost position with an appropriate identifier (title and an indication that this book is loaned).

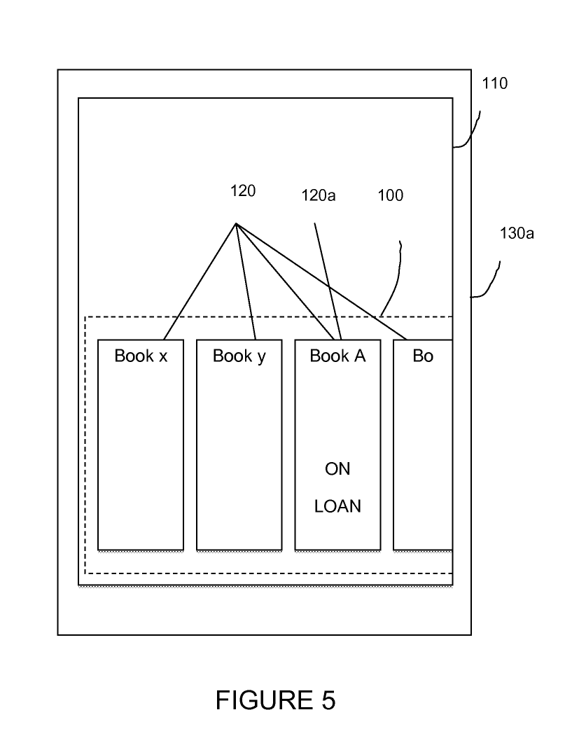

User B (or any user) can move items 120 to a different location on the shelf 100. As illustrated in FIG. 5, User B selects the newly arrived loaned book 120a by touching its representation 120a on the screen 110, and with a continuous gesture, lifting it and dropping it into the center of the shelf 100.

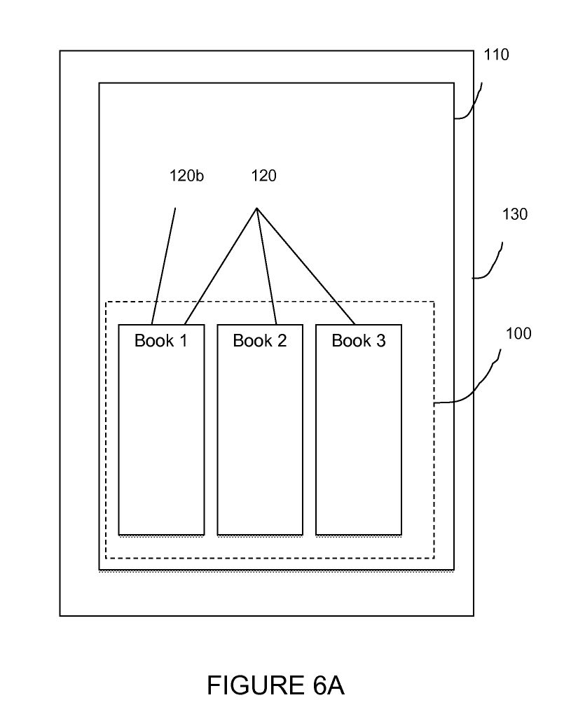

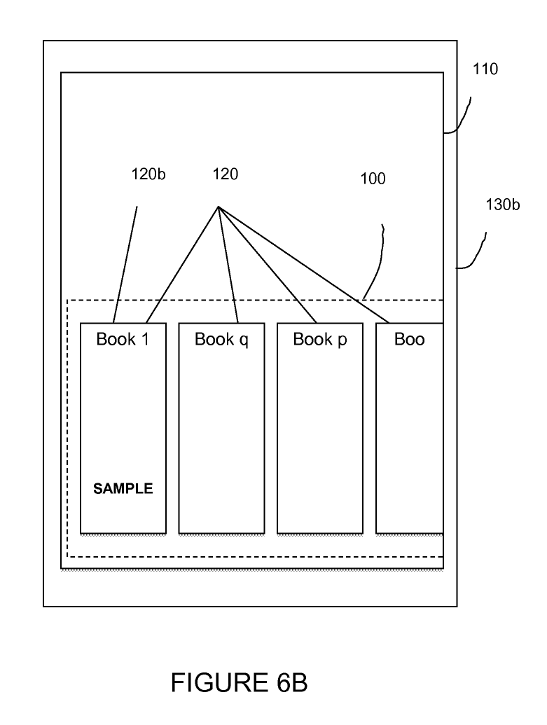

In another embodiment, users can also recommend a book to another user as illustrated in FIGS. 6A and 6B. In FIG. 6A, User A is has a book 120b open in the Reader application, and selects Share from an appropriate menu. From the “Share” menu described above, User A selects “Recommend,” and is presented with a list of contacts, including User C. User A selects User C from her contact list as the target of her recommendation.

As illustrated on FIG. 6B, User C has her shelf 100 open on her electronic reader 130b, and a sample of the book 120b recommended to her by User A appears on shelf 100 with an appropriate identifier.

The present invention, offers its users many benefits including, but not limited to the immediate recognition of the arrival of new content 120, based on the appearance of a new electronic media item 120 in the leftmost position on the shelf 100. As noted above, the appearance of this item 120 may be anticipated, as in the case that it is triggered by the action of the user who owns the shelf equipped electronic reader (e.g., she has just purchased a new item 120). Alternatively the arrival of new content 120 may be unanticipated, in the event that the appearance is triggered by a third-party initiated event. For example, an unanticipated item 120 may be loaned or recommended by another user or a sample may be provided as a promotion by a purveyor of electronic media.

In one embodiment, the user can opt out of receiving any particular type of content on his shelf 100. Device 130 has a settings application in which the user can customize the use of shelf 100. For example, a user can choose to not have newly purchased books 120 appear on the shelf 100, or choose not to have new periodical issues appear there. These new items of content items still appear in the user's library. In practice, very few users would choose to opt out of those items appearing on the shelf 100, although some might choose to opt out of putting content pushed to device 130 on the shelf 100.

Users can remove any item from the shelf using a “Remove” command. In one embodiment, the “Remove” command appears on a menu seen when the user presses and holds on the item of content 120. As described above, users can move items 120 around the shelf 100 as they desire, or move items off of the shelf 100 up to the desktop area on the home screen of device 130.

In many ways, the shelf can be thought of as an in-box, while the area above on the home screen can be thought of as the users' “coffee table” where they can drag items 120 they want to “leave out” for a while.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A method for organizing and presenting content on an electronic device comprising:
providing a graphical user interface on a display of the electronic device;
allocating a portion of the graphical user interface for graphical representations of items of content available to a user of the electronic device;
receiving a first item of new content on the electronic device;
positioning a graphical representation of the first item of new content at a first position in the allocated portion of the graphical user interface;
receiving a second item of new content on the electronic device; and
positioning a graphical representation of the second item of new content at the first position in the allocated portion of the graphical user interface.

2. The method according to claim 1, further comprising:
displacing the graphical representation of the first item of new content in the allocated portion of the graphical user interface with the graphical representation of the second item of new content.

3. The method according to claim 2, further comprising:
positioning the graphical representation of the first item of new content at a second position in the allocated portion of the graphical user interface.

4. The method according to claim 1, further comprises:
positioning each new item of content received by the electronic device at the first position in the portion of the graphical user interface.

5. The method according to claim 1, wherein the graphical user interface is a home screen of the electronic device, the allocating act further comprising:
permanently allocating the portion on the home screen.

6. The method according to claim 5, the allocating act further comprising:
permanently allocating the portion on a bottom of the home screen.

7. The method according to claim 1, further comprising:
displaying the allocated portion of the graphical user interface as a virtual shelf.

8. The method according to claim 7, wherein the first position is the leftmost position on the virtual shelf, the method further comprising:
shifting graphical representations of items of content to the right, as graphical representations of items of new content are positioned in the first position.

9. The method according to claim 7, further comprising:
scrolling the virtual shelf to the right or the left on the display of the electronic device in response to a command by the user.

10. The method according to claim 9, wherein the display of the electronic device is a touch screen, the method further comprising:
interpreting a gesture by a user on the touch screen as a command to scroll the virtual shelf.

11. The method according to claim 1, wherein the content is at least one of an electronic book, a digital periodical, a digital movie, digital music, a digital audio book, a digital pictures and a software application.

12. The method according to claim 1, wherein the graphical representations of content are covers associated with the content.

13. The method according to claim 1, wherein the act of receiving the first item of new content is in response to a user of the electronic device purchasing the first item of new content.

14. The method according to claim 1, wherein the act of receiving the first item of new content is in response to the first item of new content being loaned to a user of the electronic device.

15. The method according to claim 1, wherein the act of receiving the first item of new content is in response to the first item of new content being pushed to a user of the electronic device.

16. A method for organizing and presenting content on an electronic device comprising:
providing a graphical user interface on a display of the electronic device;
allocating a portion of the graphical user interface for graphical representations of items of content available to a user of the electronic device;
determining a first item of content resident on the electronic device which a user of the device is likely to open;
positioning a graphical representation of the first item of content at a first position in the allocated portion of the graphical user interface;
determining a second item of content on the electronic device which a user of the device is likely to open; and
positioning a graphical representation of the second item of content at the first position in the allocated portion of the graphical user interface.

17. The method according to claim 16, further comprising:
displacing the graphical representation of the first item of content in the allocated portion of the graphical user interface with the graphical representation of the second item of content; and
positioning the graphical representation of the first item of content at a second position in the allocated portion of the graphical user interface.

18. The method according to claim 16, wherein items of content that the user is likely to open comprise at least one of a new issue of a digital periodical to which the user subscribes, newly downloaded content, electronic books recommended or lent to the user and an item of content recently opened by the user.

19. An electronic device comprising:
a memory, the memory storing items of content and instructions for operating the electronic device;
a display; and
control circuitry operatively coupled to the memory and the display, the control circuitry operable to:
provide a graphical user interface on the display,
allocate a portion of the graphical user interface for graphical representations of items of content,
position a graphical representation of first new item of content at a first position in the allocated portion,
receive a second new item of content, and
position a graphical representation of the second new item of content at the first position in the allocated portion of the graphical user interface.

20. The electronic device according to claim 19, further comprising:
communications circuitry coupled to the control circuitry, the communications circuitry operable to connect to a network to enable downloading of new content.
